(19) United States
(12) Patent Application Publication
(10) Pub. No.: US 2004/0145988 A1
(43) Pub. Date: Jul. 29, 2004

(54) Method and system of creating a backup disc of a hybrid disc

(76) Inventor: Takeshi Watanabe, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/629,819

(22) Filed: Jul. 30, 2003

(30) Foreign Application Priority Data
Aug. 2, 2002 (JP) 2002-225682
Feb. 3, 2003 (JP) 2003-025798

(51) Int. Cl. G11B 7/00

(52) U.S. Cl. 369/53.22; 369/53.37

(57) ABSTRACT

A method, system and computer-readable medium are disclosed, for creating a backup disc of a hybrid disc that allows creation of a copy of a source hybrid disc properly. The method includes a qualification determination step, a loading step and a writing step. The qualification determination step determines whether or not the target optical disc is qualified as the backup disc by comparing the source optical disc to the target optical disc based on information recorded therein. The loading step loads backup information from the source optical disc when the target optical disc is qualified as the backup disc. The writing step writes the backup information in the target optical disc.

### BACKGROUND OF THE INVENTION

1. Field of the Invention

The present invention generally relates to a method of creating a backup disc of a hybrid disc and a system and a computer-readable recording medium for recording a program to implement the method, and more particularly to a method of creating a copy of a hybrid disc that includes a plurality of recording areas used as a read-only recording region and a writable recording area.

2. Description of the Related Art

Recent functional improvements in personal computers (PC) makes it possible to deal more easily with audio and visual information such as music and pictures. In general, such audio and visual information is constituted of a large amount of information. For this reason, an optical disc, for example, a CD (Compact Disc) or a DVD (Digital Versatile Disc), has been receiving much attention as a recording medium for audio and visual information because of its relatively large capacity. In addition, as a user can obtain a more affordable optical disc apparatus for recording information in such an optical disc, the optical disc apparatus has been more widely used as an information recording apparatus.

In general, so-called content information, for example, application software, still images and moving images, is conventionally recorded or stamped in a recording medium such as a CD-ROM (Compact Disc-Read Only Memory) for distribution and sale. In recent years, a hybrid disc has been developed as a CD descent optical disc. As shown in FIG. 1, the hybrid disc includes a read-only area (ROM part) and a writable area or a rewritable area (RAM part). In one proposed method, content information is recorded in advance in the ROM part of such a hybrid disc instead of a CD-ROM, and the recorded hybrid disc is distributed and sold. Hereinafter, conventional CD descent optical discs, for example, CD-ROM, CD-R (Compact Disc-Recordable) and CD-RW (Compact Disc-Rewritable), are collectively referred to as conventional CDs so as to distinguish them from a hybrid disc and other CD descent optical discs.

In some hybrid discs, the first session thereof is stamped as the ROM part so as to ensure compatibility with conventional CDs and the other areas are used as RAM part. In this configuration, even if an optical disc system cannot directly recognize a hybrid disc, the optical disc system is capable of handling the hybrid disc as a conventional Multisession CD. For this reason, it is possible to ensure at least read-compatibility. Alternatively, information indicative of a hybrid disc may be stamped at a predetermined position of the hybrid disc so as to distinguish between the hybrid disc and conventional CDs.

In addition, when most users obtain media including content information, they allow for a situation in which the content information cannot be reproduced due to damage of the media. Accordingly, most users create copies (backup discs) of the media (original media), and then keep the original media and use the copies.

Japanese Laid-Open Patent Applications No. 11-328846, 2001-118331 and 2002-190157 disclose some conventional methods and apparatuses of creating a copy of an information medium.

However, if a (original) hybrid disc is copied to another (backup) hybrid disc as a backup disc thereof, then the recorded medium (original hybrid disc) is copied to the partially recorded medium (backup disc). In the above-mentioned disclosed methods and apparatuses, since this case is not taken into consideration, there is a risk that recorded content information cannot be appropriately reproduced due to defective links between the ROM part and the RAM part of the backup hybrid disc.

In addition, when the original hybrid disc is copied to CD-R or CD-RW as the backup disc thereof, it may be impossible to reproduce the content information in the backup disc if the content information is protected in accordance with substrate information (disc information), which is specific to hybrid discs, indicative of copy protect.

### SUMMARY OF THE INVENTION

It is a general object of the present invention to provide a method of creating a backup disc of a hybrid disc in which one or more of the above-mentioned problems are eliminated, and a system for implementing the method, and a computer-readable recording medium for storing a computer executable program to implement the method.

A more specific object of the present invention is to provide a backup hybrid disc creation method that can efficiently create a backup hybrid disc.

In order to achieve the above-mentioned objects, there is provided according to one aspect of the present invention a method of creating a backup disc of a hybrid type source optical disc having a read-only storage area and a writable storage area, the method including: a qualification determination step of determining whether or not a target optical disc is qualified as the backup disc of the hybrid type source optical disc by comparing the source optical disc to the target optical disc based on information recorded in the source optical disc and the target optical disc; a loading step of loading, when it is determined that the target optical disc is qualified as the backup disc, backup information from the source optical disc; and a writing step of writing the backup information in the target optical disc.

In an embodiment of the invention, the method may further include a disc determination step of determining whether or not the target optical disc is a hybrid type disc, and wherein the qualification determination step may occur when the disc determination step determines that the target optical disc is a hybrid type disc.

In an embodiment of the invention, the method may further include a disc determination step of determining whether or not the target optical disc has predetermined compatibility with the hybrid type source optical disc, and wherein the qualification determination step may occur when the disc determination step determines that the target optical disc has predetermined compatibility with the hybrid type source optical disc.

In an embodiment of the invention, the qualification determination step may includes: a substrate qualification determination step of determining whether or not the source optical disc and the target optical disc have the same substrate information; and a ROM qualification determination step of determining whether or not at least a portion of ROM information of the source optical disc in a read-only storage area thereof and at least a portion of ROM information of the target optical disc in a read-only storage area thereof are the same, and the qualification determination step may determine that the target optical disc is qualified as the backup disc when the substrate qualification determination step determines that the source optical disc and the target optical disc have the same substrate information and the ROM qualification determination step determines that the portion of ROM information of the source optical disc and the portion of ROM information of the target optical disc are the same.

In an embodiment of the invention, the substrate information may include at least one of lead-in start time, lead-out start time and a write strategy parameter.

In an embodiment of the invention, the qualification determination step may include a dummy data determination step of determining whether or not the ROM information of the target optical disc is dummy data when the substrate qualification determination step determines that the source optical disc and the target optical disc have the same substrate information and the ROM qualification determination step determines that the portion of ROM information of the source optical disc and the portion of ROM information of the target optical disc are not the same, the qualification determination step determining, when the dummy data determination step determines that the ROM information of the target optical disc is dummy data, that the target optical disc is qualified as the backup disc.

In an embodiment of the invention, the backup information may include RAM information recorded in a writable storage area of the source optical disc, and the writing step writes the RAM information in a writable storage area of the target optical disc.

In an embodiment of the invention, the backup information may include RAM information recorded in a writable storage area of the source optical disc and the ROM information of the source optical disc, and the writing step writes the RAM information and the ROM information in a writable storage area of the target optical disc when the qualification determination step determines that the target optical disc is qualified as the backup disc based on determination of the dummy data determination step.

In an embodiment of the invention, the hybrid type disc may include a CD descent disc or a DVD descent disc.

According to one aspect of the present invention, when a target optical disc is qualified as a hybrid disc of a hybrid type source optical disc, information is loaded from the source optical disc and written in a writable storage area of the target optical disc so as to create a backup hybrid disc. As a result, it is possible to copy the source optical disc to the target optical disc as the backup hybrid disc. Additionally, if the target optical disc is not qualified for the backup hybrid disc, the source optical disc is not allowed to be copied to the target optical disc. As a result, it is possible to prevent creation of an unavailable backup disc.

In addition, when the target optical disc is qualified as the backup disc and further at least a portion of ROM information of the source optical disc and at least a portion of ROM information of the target optical disc have the same ROM information, then information is loaded from the source optical disc and written in a writable storage area of the target optical disc so as to create a backup hybrid disc. In this case, after determination of consistency between the portion of ROM information of the source optical disc and the target optical disc, the source optical disc is copied to the target optical disc as the backup hybrid disc. As a result, it is possible to prevent creation of a copy of the source optical disc improperly.

In addition, even if the target optical disc is qualified as a backup disc and the source optical disc and the target optical disc do not have the same ROM information, then information is loaded from the source optical disc and written in a writable storage area of the target optical disc, as long as the target ROM information recorded in the read-only storage area of the target optical disc is dummy data. As a result, even if the target optical disc, whose ROM information is different from that of the source optical disc, is prepared as the backup hybrid disc, it is possible to copy information recorded in the source optical disc to the target optical disc properly. Therefore, it is unnecessary to prepare a target optical disc that has the same ROM information as the source optical disc.

Additionally, there is provided according to another aspect of the present invention a system of creating a backup disc of a hybrid type source optical disc having a read-only storage area and a writable storage area, including: a qualification determination part determining whether or not a target optical disc is qualified as the backup disc of the hybrid type source optical disc by comparing the source optical disc to the target optical disc based on information recorded in the source optical disc and the target optical disc; a loading part loading, when it is determined that the target optical disc is qualified as the backup disc, backup information from the source optical disc; and a writing part writing the backup information in the target optical disc.

Additionally, there is provided according to another aspect to the present invention a computer-readable recording medium for storing a program to cause a computer to execute a procedure of creating a backup disc of a hybrid type source optical disc having a read-only storage area and a writable storage area, the procedure including: a qualification determination step of determining whether or not a target optical disc is qualified as the backup disc of the hybrid type source optical disc by comparing the source optical disc to the target optical disc based on information recorded in the source optical disc and the target optical disc; a loading step of loading, when it is determined that the target optical disc is qualified as the backup disc, backup information from the source optical disc; and a writing step of writing the backup information in the target optical disc.

According to the above-mentioned inventions, the above-mentioned backup hybrid disc creation method can be implemented by an apparatus and a computer that can easily obtained.

Other objects, features and advantages of the present invention will become more apparent from the following detailed description when read in conjunction with the accompanying drawings.

### BRIEF DESCRIPTION OF THE DRAWINGS

FIG. 1 is a plan view of a hybrid disc;

FIG. 2 is a plan view of a hybrid disc to which a backup hybrid disc creation method according to the present invention is applied;

FIG. 3 is a flowchart of a procedure of a backup hybrid disc creation method according to one embodiment of the present invention;

FIG. 4 is a flowchart of a procedure of a backup hybrid disc creation method according to another embodiment of the present invention;

FIG. 5 is a flowchart of a procedure of a backup hybrid disc creation method according to another embodiment of the present invention;

FIG. 6 is a block diagram illustrating a structure of a hardware system to implement the backup hybrid disc creation method according to the present invention;

FIG. 7 is a block diagram illustrating a structure of an information record system according to one embodiment of the present invention;

FIG. 8 is a block diagram illustrating a structure of an optical pickup device of the information record system in FIG. 7;

FIG. 9 is a block diagram illustrating a structure of the reproduction signal processing circuit of the information record system in FIG. 7;

FIG. 10 is a flowchart of a portion of a backup hybrid disc creation process executed by the information record system in FIG. 7;

FIG. 11 is a flowchart of the remaining portion of the backup hybrid disc creation process executed by the information record system in FIG. 7;

FIG. 12 is a block diagram illustrating a structure of an information record system according to another embodiment of the present invention;

FIG. 13 is a flowchart of a portion of a backup hybrid disc creation process executed by the information record system in FIG. 12; and

FIG. 14 is a flowchart of the remaining portion of the backup hybrid disc creation process executed by the information record system in FIG. 12.

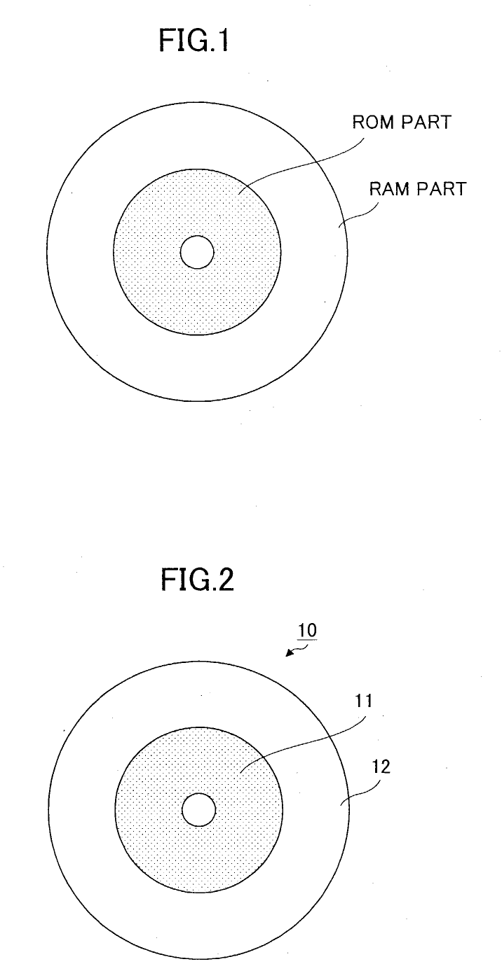

### DETAILED DESCRIPTION OF THE PREFERRED EMBODIMENTS

In the following, embodiments of the present invention will be described with reference to the accompanying drawings.

According to a method of creating a backup hybrid disc according to the present invention, when both a source disc and a target disc are hybrid discs, information recorded in the source disc is read out and then the read information is written in the RAM part of the target disc so as to create a copy of the source disc.

A description will now be given, with reference to FIG. 2, of a hybrid disc to which a backup hybrid disc creation method according to the present invention is applied.

FIG. 2 is a plan view of an exemplary hybrid disc 10. Referring to FIG. 2, the hybrid disc 10 comprises a ROM part 11 as a read-only storage area and a RAM part 12 as a writable storage area. The ROM part 11 is used to stamp (record) application software or some data in advance. In addition, the hybrid disc 10 contains information that indicates that the disc 10 is a hybrid disc. For example, such information may be formed as a Disc Application Code of ATIP (Absolute Time In Pre-groove).

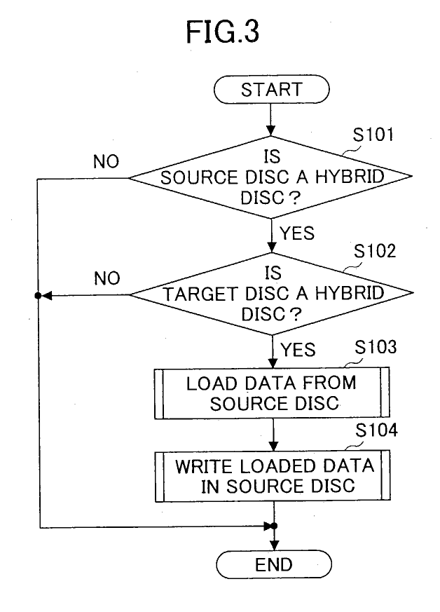

A description will now be given, with reference to FIG. 3, of a backup hybrid disc creation method according to one embodiment of the present invention.

FIG. 3 is a flowchart of a procedure of the backup hybrid disc creation method. Referring to FIG. 3, when the backup hybrid disc creation process according to this embodiment starts, it is determined whether or not a given source disc is a hybrid disc based on the stamped information indicating that the disc is a hybrid disc at step S101. If the source disc is a hybrid disc (step S101: YES), it is determined whether or not a given target disc is a hybrid disc based on stamped information indicating that the disc is a hybrid disc at step S102. If the target disc is also the hybrid disc (step S102: YES), information recorded in the source hybrid disc is loaded at step S103 and the loaded information is written in the target hybrid disc at step S104.

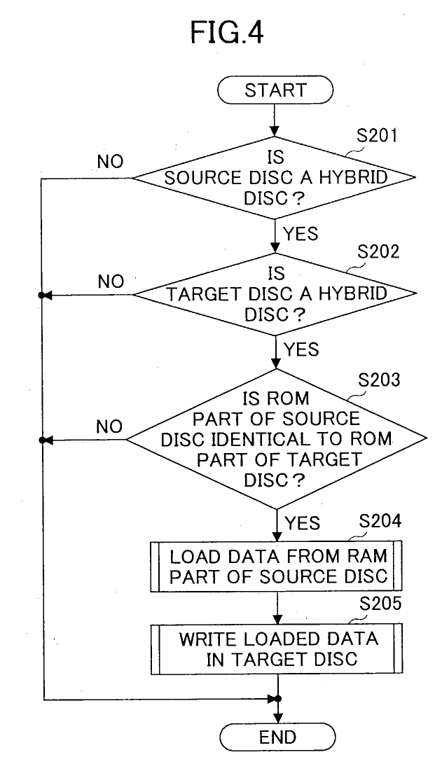

A description will now be given, with reference to FIG. 4, of a backup hybrid disc creation method according to another embodiment of the present invention.

FIG. 4 is a flowchart of a procedure of the backup hybrid disc creation method. Referring to FIG. 4, when the backup hybrid disc creation process according to this embodiment starts, it is determined whether or not a given source disc is a hybrid disc based on the stamped information indicative of the hybrid disc at step S201. If the source disc is a hybrid disc (step S201: YES), it is determined whether or not a given target disc is a hybrid disc based on the stamped information indicative of the hybrid disc at step S202. If the target disc is also a hybrid disc (step S202: YES), information recorded in the ROM part of the source hybrid disc is compared to information recorded in the ROM part of the target hybrid disc at step S203. If the source hybrid disc and the target hybrid disc have the same ROM information (step S203: YES), information recorded in the RAM part of the source hybrid disc is loaded at step S204 and the loaded information is written in the target hybrid disc at step S205.

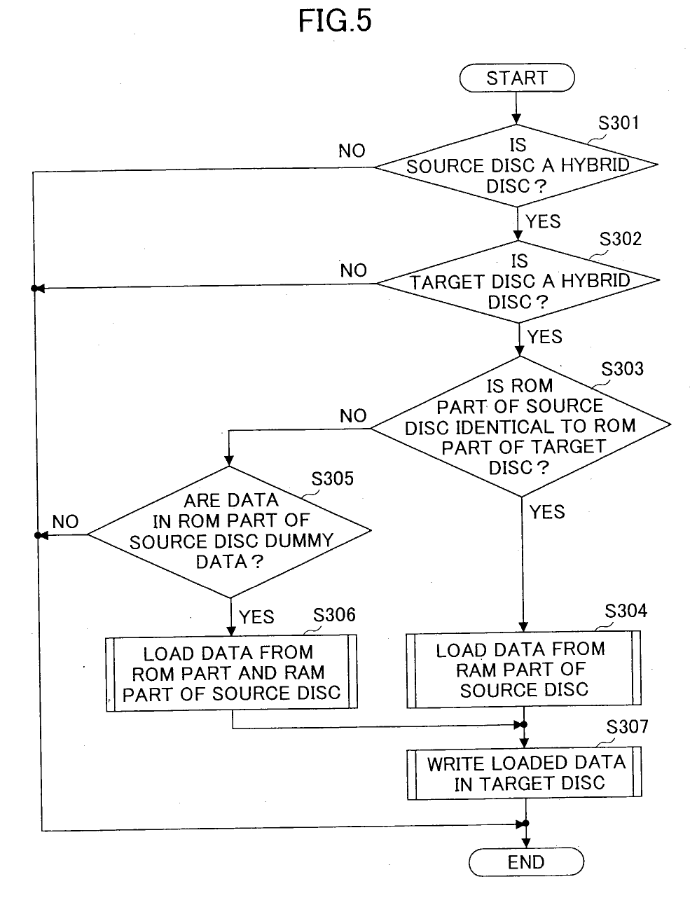

A description will now be given, with reference to FIG. 5, of a backup hybrid disc creation method according to another embodiment of the present invention.

FIG. 5 is a flowchart of a procedure of a backup hybrid disc creation method. Referring to FIG. 5, when the backup hybrid disc creation process according to this embodiment starts, it is determined whether or not a given source disc is a hybrid disc based on the stamped information indicative of the hybrid disc at step S301. If the source disc is a hybrid disc (step S301: YES), it is determined whether or not a given target disc is a hybrid disc based on the stamped information indicative of the hybrid disc at step S302. If the target disc is also a hybrid disc (step S302: YES), information recorded in the ROM part of the source hybrid disc is compared to information recorded in the ROM part of the target hybrid disc at step S303. If the source hybrid disc and the target hybrid disc have the same ROM information (step S303: YES), information recorded in the RAM part of the source hybrid disc is loaded at step S304. On the other hand, if the source hybrid disc and the target hybrid disc do not have the same ROM information (step S303: NO), it is further determined whether or not the information recorded in the ROM part of the target hybrid disc is dummy data at step S305. If the information is dummy data (step S305: YES), information recorded in the ROM part and the RAM part of the source hybrid disc is loaded at step S306, and then the loaded information is written in the target hybrid disc at step S307.

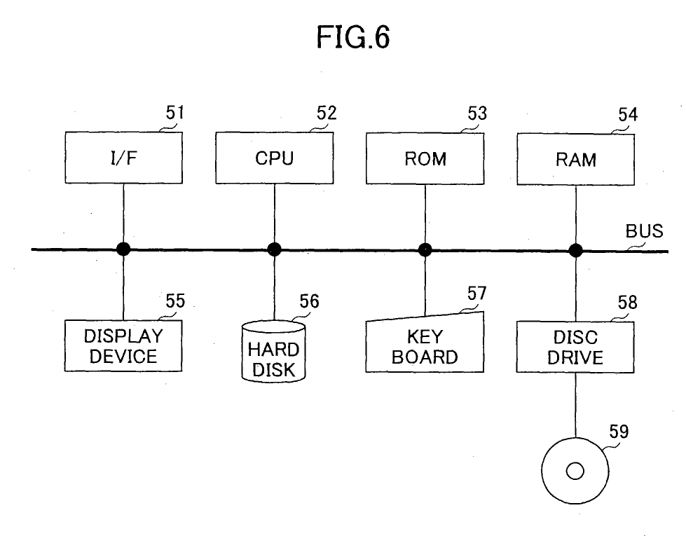

A description will now be given, with reference to FIG. 6, of an exemplary hardware system to implement the backup hybrid disc creation method according to the present invention.

FIG. 6 is a block diagram illustrating the structure of the exemplary hardware system. A program to implement the backup hybrid disc creation method is executed by the illustrated hardware system configured from a microprocessor and other devices. Referring to FIG. 6, the hardware system according to the present invention comprises an interface (I/F) 51, a CPU (Central Processing Unit) 52, a ROM 53, a RAM 54, a display device 55, a hard disk 56, a keyboard 57 and a disc drive 58. The program to implement the backup hybrid disc creation method according to the present invention is stored in a readable recording medium such as a CD-ROM 59.

When a control signal is supplied from an external apparatus to the hardware system via I/F 51, the program to implement the backup hybrid disc creation method according to the present invention starts automatically or in accordance with an instruction given by an operator via the keyboard 57. The CPU 52 performs the above-mentioned backup hybrid disc creation process in accordance with the program. The process result is stored in a storage device such as RAM 54 or the hard disk 56. In addition, if necessary, the process result may be displayed on the display device 55. In this fashion, the backup hybrid disc creation method according to the present invention is implemented by such an implementation program. Therefore, it is possible to easily implement the backup hybrid disc creation method according to the present invention by using a known computer system without any modification.

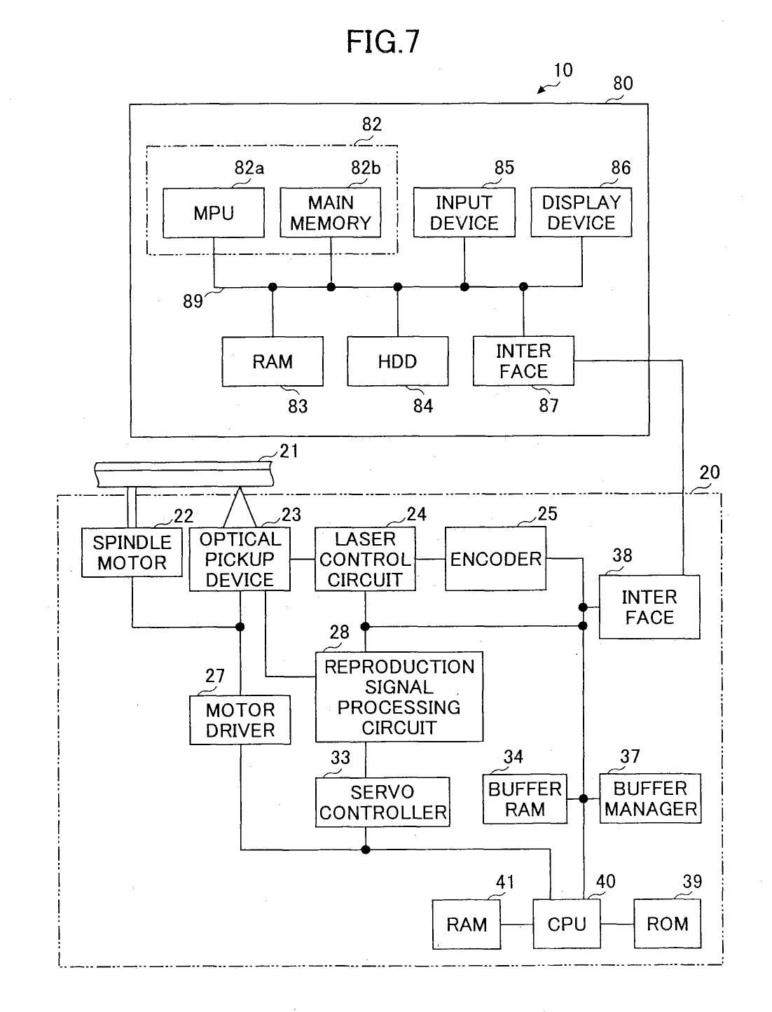

A description will now be given, with reference to FIG. 7, of a structure of an information record system according to one embodiment of the present invention.

FIG. 7 is a block diagram illustrating the structure of an information record system 10 according to this embodiment. Referring to FIG. 7, the information record system 10 comprises an optical disc apparatus 20 and a host 80. The optical disc apparatus 20 serves as an information record apparatus. The host 80 serves as an information processing apparatus to control the optical disc apparatus 20. Here, (solid) connection lines illustrated in FIG. 7 indicate flows of signals and data. It is noted that the connection lines do not represent all connection relations between components of the information record system in FIG. 7.

As shown in FIG. 7, the optical disc apparatus 20 comprises a spindle motor 22 for rotating an optical disc 21 as an information recording medium, an optical pickup device 23, a laser control circuit 24, an encoder 25, a motor driver 27, a reproduction signal processing circuit 28, a servo controller 33, a buffer RAM 34, a buffer manager 37, an interface 38, a ROM 39, a CPU 40 and a RAM 41. Here, the optical disc apparatus 20 can deal with an information recording medium based on a CD standard.

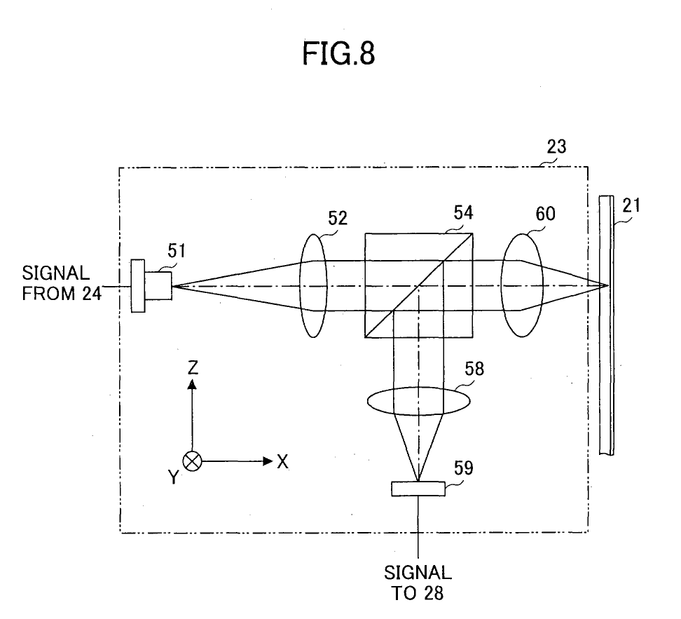

Each component of the optical disc apparatus 20 is described in detail. The optical pickup device 23 emits a laser beam on the recorded surface of the optical disc 21, in which a track is spirally or concentrically formed, and receives light reflected on the recorded surface. FIG. 8 is a block diagram illustrating the structure of the optical pickup device 23. Referring to FIG. 8, the optical pickup device 23 comprises an illuminant unit 51, a collimate lens 52, a beam splitter 54, an objective lens 60, a detection lens 58, a receiver 59 and a drive system (not illustrated) such as a focusing actuator, a tracking actuator and a seek motor.

The illuminant unit 51 comprises a semiconductor laser (not illustrated) that can emit an optical beam of 780 nm in wavelength. In this embodiment, the illuminant unit 51 is arranged to emit an optical beam in the X direction as indicated by the arrow in FIG. 8.

The collimate lens 52 is disposed in the X direction with respect to the illuminant unit 51. The collimate lens 52 converts the optical beam emitted by the illuminant unit 51 into an approximately parallel ray.

The beam splitter 54 is disposed in the X direction with respect to the collimate lens 52. The beam splitter 54 splits return light reflected on the optical disc 21 so that the return light is guided in the direction opposite to the Z direction as indicated by the arrow in FIG. 8.

The objective lens 60 is disposed in the X direction with respect to the beam splitter 54. The objective lens 60 focuses the optical beam transmitted through the beam splitter 54 on the recorded surface of the optical disc 21 so as to form an optical spot to record and reproduce data in the optical disc 21.

The detection lens 58 is disposed in the direction opposite to the Z direction with respect to the beam splitter 54. The detection lens 58 focuses the return light split by the beam splitter 54 on the receiver surface of the receiver 59. Similarly to a conventional optical pickup device, the receiver 59 supplies a plurality of signals, which include wobble signal information, reproduction data, focusing error information and tracking error information, to the reproduction signal processing circuit 28.

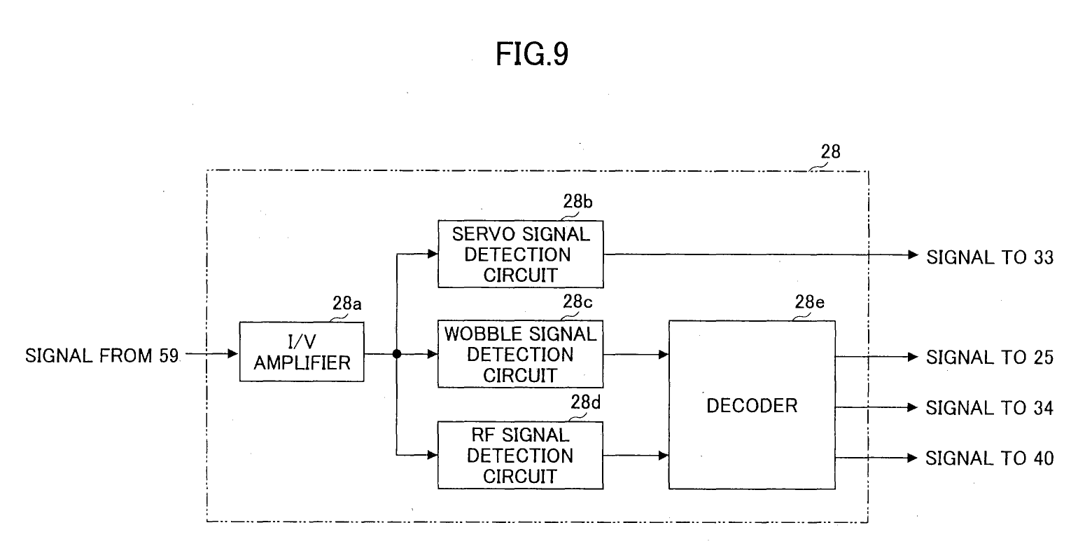

Next, the reproduction signal processing circuit 28 of the information record system is described. FIG. 9 is a block diagram illustrating the structure of the reproduction signal processing circuit 28. Referring to FIG. 9, the reproduction signal processing circuit 28 comprises an I/V amplifier 28a, a servo signal detection circuit 28b, a wobble signal detection circuit 28c, an RF signal detection circuit 28d and a decoder 28e.

The I/V amplifier 28a converts a current signal as an output signal of the receiver 59 into a voltage signal. The servo signal detection circuit 28b detects a servo signal (a focusing error signal or a tracking error signal) based on an output signal of the I/V amplifier 28a and supplies the detected servo signal to the servo controller 33. The wobble signal detection circuit 28c detects a wobble signal based on the output signal of the I/V amplifier 28a and supplies the detected wobble signal to the decoder 28e. The RF signal detection circuit 28d detects an RF signal based on the output signal of the I/V amplifier 28a and supplies the detected RF signal to the decoder 28e.

The decoder 28e extracts ATIP information and a synchronizing signal from the wobble signal detected by the wobble signal detection circuit 28c. The extracted ATIP information and the synchronizing signal are supplied to the CPU 40 and the encoder 25, respectively. In addition, after a decoding process and an error correction process for the RF signal detected by the RF signal detection circuit 28d, the decoder 28e stores the resulting signal as reproduction data in the buffer RAM 34 via the buffer manager 37. Here, if the reproduction data are formed of audio data, the resulting signal is supplied to an external audio device via a D/A converter (not illustrated).

As shown in FIG. 7, the servo controller 33 generates a control signal for correcting a misaligned focus based on a focusing error signal from the reproduction signal processing circuit 28 and a control signal for correcting a misaligned track based on a tracking error signal. The servo controller 33 supplies these control signals to the motor driver 27.

In response to the control signals from the servo controller 33, the motor driver 27 drives the focusing actuator and the tracking actuator of the optical pickup device 23. Hence, it is understood that the tracking control and the focus control is performed in collaboration with the servo signal detection circuit 28b, the servo controller 33 and the motor driver 27. Furthermore, the motor driver 27 drives the spindle motor 22 and the seek motor of the optical pickup device 23 in accordance with an instruction issued by the CPU 40.

Based on an instruction issued by the CPU 40, the encoder 25 fetches data stored in the buffer RAM 34 via the buffer manager 37 and performs some processes such as data modulation and attachment of an error correction code for the data so as to generate a write signal to the optical disc 21. Then, the encoder 25 supplies the write signal to the laser control circuit 24 synchronously with the synchronizing signal from the reproduction signal processing circuit 28.

The laser control circuit 24 generates a control signal for controlling an output level of the illuminant unit 51 of the optical pickup device 23 based on the write signal from the encoder 25 and an instruction issued by the CPU 40.

The interface 38 serves as a bidirectional communication interface between the optical disc apparatus 20 and the host 80. The interface 38 operates in compliance with a standard interface such as ATAPI (AT Attachment Packet Interface), SCST (Small Computer System Interface), USB (Universal Serial Bus), IEEE1394, and any other suitable interface, as will be appreciated by those skilled in the art.

The ROM 39 maintains programs described as codes executable by the CPU 40. The CPU 40 controls the above-mentioned components of the optical disc apparatus 10 in accordance with the programs in the ROM 39. The CPU 40 temporarily stores necessary data in the RAM 41.

On the other hand, the host 80 comprises a main control device 82, RAM 83, a hard disk (HDD) 84 as a recording medium, an input device 85, a display device 86 and an interface 87. These components are connected via a common bus 89.

The main control device 82 comprises a microcomputer (MPU) 82a and a main memory 82b. The main control device 82 controls the entire host 80 and temporarily stores data necessary for the control in the RAM 83.

The interface 87 serves as a communication interface in compliance with the same standard as the interface 38 of the optical disc apparatus 20. The interface 87 is connected with the interface 38. The interfaces 38 and 87 may be connected by means of communication cables such as SCSI cables. Alternatively, the interfaces 38 and 87 may be wireless-connected by means of infrared radiation or the like.

The HDD 84 maintains programs described as codes executable by the MPU 82a. The programs include a backup hybrid disc creation program, which starts in response to a user's request of a backup hybrid disc creation, according to the present invention to be mentioned later in detail.

The display device 86 comprises a display part (not illustrated), for example, a CRT (Cathode Ray Tube), a LCD (Liquid Crystal Display) and a PDP (Plasma Display Panel). The display device 86 displays various information in accordance with an instruction issued by the MPU 82a.

The input device 85 comprises, for example, at least one of a keyboard, a mouse, a tablet, a track ball, a light pen and a touch panel. The input device 85 delivers user's input data to the MPU 82a. The data may be received wireless from these input means. The display device 86 and the input device 85 may be integrally configured, for example, as a CRT with a touch panel.

The optical disc 21 maintains in advance substrate information that includes lead-in start time, lead-out start time and some parameters related to the write strategy thereof. For the lead-in start time, time specific to each manufacturer is set as a vendor code. For the lead-out start time, a value is set corresponding to the record capacity of the optical disc 21. Here, the substrate information is not allowed to be copied to another optical disc. In addition, if the optical disc 21 is a hybrid disc, information indicative of this fact that the optical disc 21 is a hybrid disc is included as a portion of the substrate information in a disc application code in the above-mentioned ATIP information.

A description will now be given of a data recording operation of the information record system 10 in response to a user's request.

When a user designates data via the input device 85 and requests the host 80 to record the data in the optical disc 21, the MPU 82a issues a recording request command to the optical disc apparatus 20 via the interface 87.

In response to a reception of the recording request command from the host 80 via the interface 38, the optical disc apparatus 20 starts the data recording operation.

The CPU 40 generates a control signal for controlling rotation of the spindle motor 22 based on a given recording speed and supplies the control signal to the motor driver 27. At the same time, the CPU 40 informs the reproduction signal processing circuit 28 that the CPU 40 has received the recording request command. In addition, the CPU 40 instructs the buffer manager 37 to store data (which may be referred to as user data) received from the host 80 in the buffer RAM 34.

When the rotational speed of the optical disc 21 reaches a predetermined linear speed, the reproduction signal processing circuit 28 detects a tracking error signal and a focusing error signal based on an output signal of the receiver 59 and supplies the detected signals to the servo controller 33. It is possible to correct a misaligned track and a misaligned focus in accordance with the above-mentioned fashion by using the tracking error signal and the focusing error signal. Here, it is noted that tracking errors and focusing errors are being corrected until the data recording operation is completed. In addition, the reproduction signal processing circuit 28 obtains ATIP information based on the output signal of the receiver 59 and informs the CPU 40 of the ATIP information. Here, it is noted that the reproduction signal processing circuit 28 is gaining the ATIP information at a predetermined time interval until the data recording operation is completed and informs the CPU 40 of the current ATIP information.

The CPU 40 supplies a seek motor control signal to the motor driver 27 so as to move the optical pickup device 23 at the writing start position based on the ATIP information. When the CPU 40 receives from the buffer manager 37 a notification that a data amount of the user data in the buffer PAM 34 exceeds a predetermined amount, the CPU 40 instructs the encoder 25 to generate a write signal.

When the optical pickup device 23 reaches the writing start position, the CPU 40 notifies the encoder 25 of this fact. In this manner, the user data are written in the optical disc 21 via the encoder 25, the laser control circuit 24 and the optical pickup device 23. After the user data from the host 80 have been written, the data recording operation is terminated.

A description will now be given of a file reproduction operation of the information record system 10 for reproducing a data file recorded in the optical disc 21 in response to a user's request.

When a user designates a file via the input device 85 and requests the host 80 to reproduce the file, the MPU 82a issues a reproduction request command to the optical disc apparatus 20 via the interface 87.

In response to receipt of the reproduction request command from the host 80 via the interface 38, the optical disc apparatus 20 starts the file reproduction operation.

The CPU 40 generates a control signal for controlling rotation of the spindle motor 22 based on a given reproduction speed and supplies the control signal to the motor driver 27. At the same time, the CPU 40 informs the reproduction signal processing circuit 28 that the CPU 40 has received the reproduction request command.

When the rotational speed of the optical disc 21 reaches a predetermined linear speed, a misaligned track and a misaligned focus are corrected similarly to the above-mentioned fashion. Here, it is noted that the tracking error and the focusing error are being corrected until the file reproduction operation is completed.

The CPU 40 supplies a seek motor control signal to the motor driver 27 so as to move the optical pickup device 23 at the writing start position based on the ATIP information.

When the optical pickup device 23 reaches the writing start position, the CPU 40 notifies the encoder 25 of this fact. Then, the reproduction signal processing circuit 28 detects an RF signal from an output signal of the receiver 59 and performs a decoding process and an error correction process for the detected RF signal. Then, the resulting signal is accumulated as reproduction data in the buffer RAM 34. The reproduction data are being accumulated in the buffer RAM 34 until the reproduction data become sector data. After the accumulation of the reproduction data is completed, the reproduction data are delivered to the host 80 via the interface 38.

According to the above-mentioned recording and reproduction operations of the information record system 10, the optical disc apparatus 20 makes it possible to not only record designated information in a designated area of the optical disc 21 in response to the recording request command from the host 80 but also reproduce information recorded at a designated area of the optical disc 21 in response to the reproduction request command from the host 80.

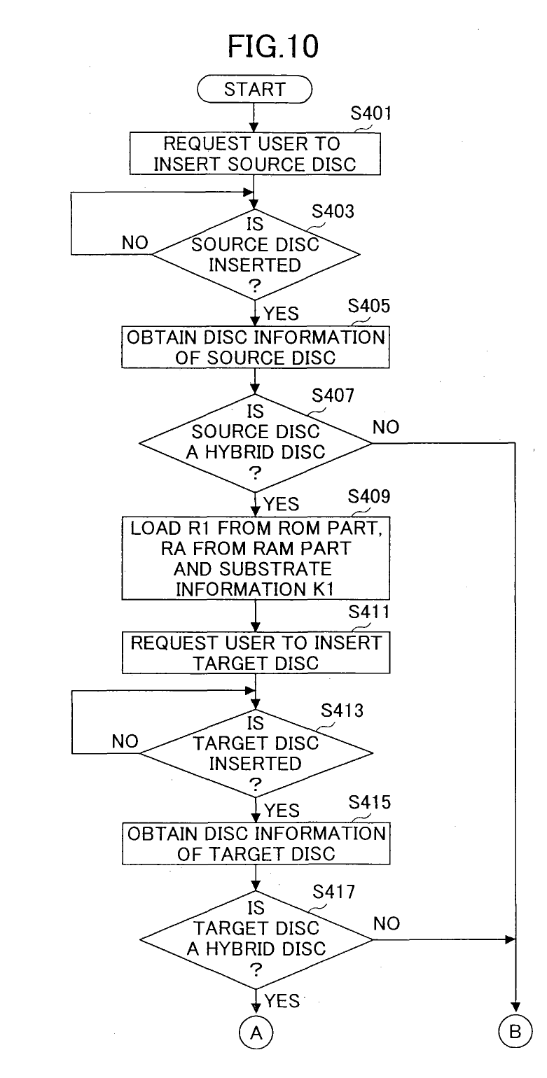

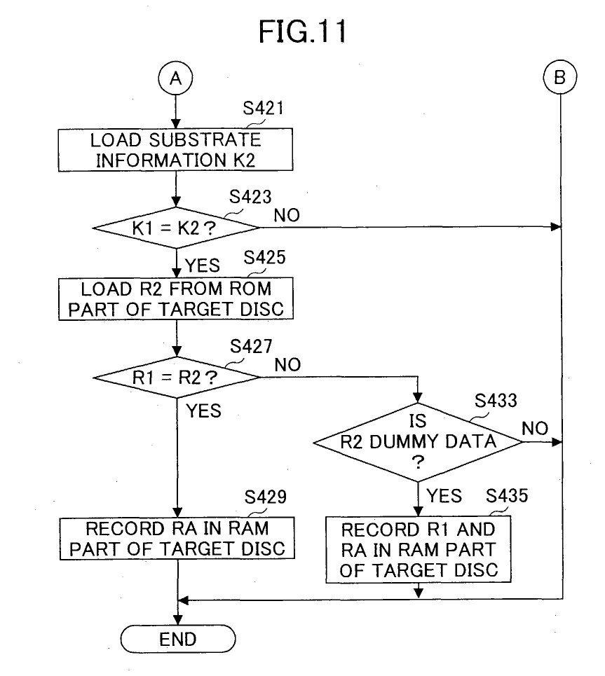

A description will now be given, with reference to FIG. 10 and FIG. 11, of an exemplary backup hybrid disc creation operation of the information record system 10 in response to a user's request.

FIG. 10 and FIG. 11 are a flowchart of the exemplary backup hybrid disc creation operation. The flowchart in FIG. 10 and FIG. 11 corresponds to an algorithm for a sequence of processes executed by the MPU 82a. When a user instructs the information record system 10 to create a backup hybrid disc via the input device 85, the program corresponding to the algorithm in FIG. 10 and FIG. 11 is loaded from the HDD 84 to the main memory 82b. Then, the head address is set in a program counter of the MPU 82a, and the information record system 10 starts the backup disc creation operation.

At step S401, a message is displayed on the display device 86 so as to prompt the user to insert a source optical disc, from which a backup hybrid disc is created, into the optical disc apparatus 20.

At step S403, it is determined whether or not the source optical disc is inserted into the optical disc apparatus 20. If the MPU 82a receives from the optical disc apparatus 20 a notification that the source optical disc has been inserted, the MPU 82a determines that the source optical disc is inserted (step S403: YES) and then moves to step S405.

At step S405, the MPU 82a obtains disc information recorded in the source optical disc via the optical disc apparatus 20.

At step S407, the MPU 82a determines whether or not the source optical disc is a hybrid disc with reference to the disc information of the source optical disc. If the source optical disc is not a hybrid disc (step S407: NO), the MPU 82a displays on the display device 86 a message indicating that the source optical disc is not a hybrid disc and terminates the backup hybrid disc creation operation without creation of the backup hybrid disc. On the other hand, if the source optical disc is a hybrid disc (S407: YES), the MPU 82a moves to the step S409.

At step S409, the MPU 82a loads information R1 from the ROM part of the source optical disc, information RA from the RAM part of the source optical disc and lead-in start time K1 as substrate information of the source optical disc.

At step S411, the source optical disc is ejected from the optical disc apparatus 20. Then, a message is displayed on the display device 86 so as to prompt the user to insert a target optical disc into the optical disc apparatus 20.

At step S413, the MPU 82a determines whether or not the target optical disc is inserted into the optical disc apparatus 20. If the MPU 82a receives from the optical disc apparatus 20 a notification that the target optical disc has been inserted, the MPU 82a determines that the target optical disc is inserted into the optical disc apparatus 20 (S413: YES) and then moves to step S415.

At step S415, the MPU 82a obtains disc information recorded in the target optical disc via the optical disc apparatus 20.

At step S417, the MPU 82a determines whether or not the target optical disc is a hybrid disc with reference to the disc information of the target optical disc. If the target optical disc is not a hybrid disc (step S417: NO), the MPU 82a displays on the display device 86 a message indicating that the target optical disc is not a hybrid disc and terminates the backup hybrid disc creation operation without creation of the backup hybrid disc. On the other hand, if the target optical disc is a hybrid disc (S417: YES), the MPU 82a moves to the step S421.

At step S421 (FIG. 11), the MPU 82a loads lead-in start time K2 as substrate information of the target optical disc.

At step S423, the MPU 82a determines whether or not the lead-in start time K1 of the source optical disc is equal to the lead-in start time K2 of the target optical disc. If the lead-in start time K1 of the source optical disc is not equal to the lead-in start time K2 of the target optical disc (S423: NO), the MPU 82a displays on the display device 86 a message indicating that the target optical disc is not qualified as a backup hybrid disc and terminates the backup hybrid disc creation operation without creation of the backup hybrid disc. On the other hand, if the lead-in start time K1 of the source optical disc is equal to the lead-in start time K2 of the target optical disc (S423: YES), the MPU 82a determines that the target optical disc is qualified as a backup hybrid disc and then moves to step S425.

At step S425, the MPU 82a loads information R2 from the ROM part of the target optical disc via the optical disc apparatus 20.

At step S427, it is determined whether or not the information R1 is identical to the information R2. If the information R1 is identical to the information R2 (step S427: YES), the MPU 82a moves to step S429.

At step S429, the MPU 82a records the information RA in the RAM part of the target optical disc via the optical disc apparatus 20. Namely, the information recorded in the RAM part of the source optical disc is copied to the RAM part of the target optical disc. The MPU 82a displays on the display device 86 a message indicating that the backup hybrid disc has been properly created and then terminates the backup hybrid disc creation operation.

On the other hand, if the information R1 is not identical to the information R2 (step S427: NO), the MPU 82a moves to step S433.

At step S433, it is determined whether or not the information R2 is predetermined dummy data. If the information R2 is not dummy data (S433: NO), the MPU 82a terminates the backup hybrid disc creation operation without creation of the backup hybrid disc. On the other hand, if the information R2 is the dummy data (S433: YES), the MPU 82a moves to step S435.

At step S435, the MPU 82a records the information R1 and the RA in the RAM part of the target optical disc. Namely, information recorded in the ROM part and the RAM part of the source optical disc is copied to the RAM part of the target optical disc. The MPU 82a displays on the display device 86 the message indicating that the backup disc has been properly created and then terminates the backup hybrid disc creation operation.

From the above description, it will be understood that the MPU 82a and the above-mentioned program (algorithm) executed by the MPU 82a embodies a disc determination part, a qualification determination part, which comprises a substrate qualification determination part, a ROM qualification determination part and a dummy data qualification determination part, a loading part and a writing part in the information record system according to the present invention. In detail, the substrate qualification determination part is implemented through the process at step S423. The ROM qualification determination part is implemented through the process at step S427. The writing part is implemented through the processes at steps S429 and S435. The dummy data determination part is implemented through the process at step S433. However, it will be understood that the present invention is not necessarily limited to this embodiment. Although the above-mentioned information record system is implemented in the form of the backup hybrid disc creation program or the backup hybrid disc creation software, it will be understood that a portion or all of the information record system may be implemented in the form of hardware by substituting some components of the information record system for some appropriate implementation devices.

Also, it is noted that individual steps of the backup hybrid disc creation method can be implemented through the above-mentioned processes. Namely, a substrate qualification determination step is implemented through the process at step S423. A ROM qualification determination step is implemented through the process at step S427. A writing step is implemented through the processes at steps S429 and S435. A dummy data qualification step is implemented through the process at step S433.

Also, the backup hybrid disc creation program according to the present invention can be configured corresponding to the above-mentioned processes illustrated by the flowchart in FIG. 10 and FIG. 11. The backup hybrid disc creation program may be stored in the HDD 84.

According to the above-mentioned information record system, when the host 80 receives a backup hybrid disc creation request from a user, the MPU 82a performs the backup hybrid disc creation process. In the backup hybrid disc creation process, if the lead-in start time of a source optical disc is equal to the lead-in start time of a target optical disc, it is determined that the target optical disc is qualified as a backup hybrid disc; that is, qualification determination is made. In this case, even if the substrate information of the source optical disc, which is characteristic of the source hybrid disc, protects content information in the source optical disc, it is possible to properly reproduce the content information copied to the target optical disc because the source optical disc and the target optical disc have the same substrate information.

In addition, after the target optical disc is determined to be a qualified backup hybrid disc, it is determined whether or not the ROM part of the source optical disc is identical to the ROM part of the target optical disc; that is, ROM determination is made. Normally, it takes extremely less time to make the qualification determination than the ROM determination. Therefore, if the target optical disc is determined to be not qualified for the backup hybrid disc based on the qualification determination, it is possible to tell a user backup impossibility earlier than a case in which the qualification determination is made after the ROM determination. However, if the ROM part possesses a less amount of data or has a small recording capacity, the qualification determination may be made after the ROM determination.

In addition, after the ROM part of the source optical disc is determined to be not identical to the ROM part of the target optical disc in accordance with the ROM determination, it is determined whether or not the information R2 is predetermined dummy data in accordance with the above-mentioned embodiment; that is, dummy data determination is made. However, if it is obvious that the information R2 is not the predetermined dummy data, the dummy data determination does not have to be made. Namely, if the information R1 is not identical to the information R2, the message indicative of backup impossibility may be displayed on the display device 86 and then the backup hybrid disc creation operation may be terminated. Furthermore, if the RAM part of the target optical disc does not have a capacity enough to maintain the information R1 and RA to be copied, the dummy data determination does not have to be made.

According to the above-mentioned embodiment, the information record system comprises the single optical disc apparatus 20. However, the information record system according to the present invention is not limited to this configuration. The information record system may comprise a plurality of optical disc apparatuses.

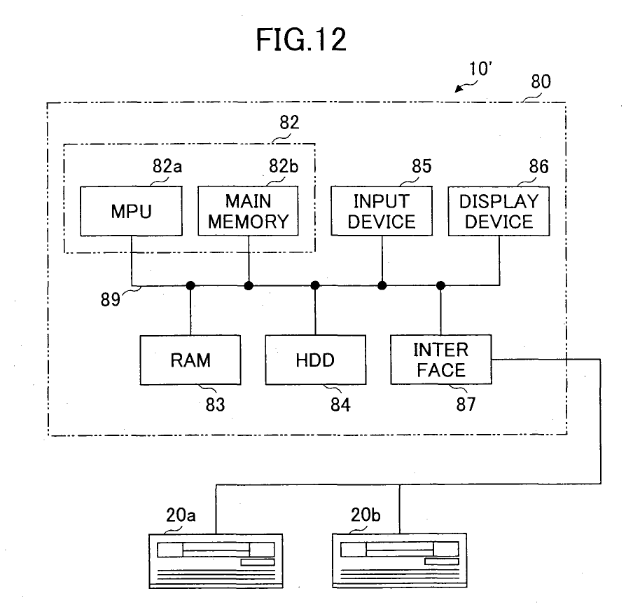

A description will now be given, with reference to FIG. 12 through FIG. 14, of an information record system, which system comprises a plurality of optical disc apparatuses, according to another embodiment of the present invention.

FIG. 12 is a block diagram illustrating the structure of an information record system 10′ according to this embodiment. Referring to FIG. 12, the information record system 10′ comprises two optical disc apparatuses 20a and 20b. Here, the two optical disc apparatuses have the same configuration and function as the above-mentioned optical disc apparatus 20. One of the two optical disc apparatuses (the optical disc apparatus 20a) is dedicated to a source optical disc and the other (the optical disc apparatus 20b) is dedicated to a target optical disc. In this case, an operator can create a backup hybrid disc without exchange between the source optical disc and the target optical disc.

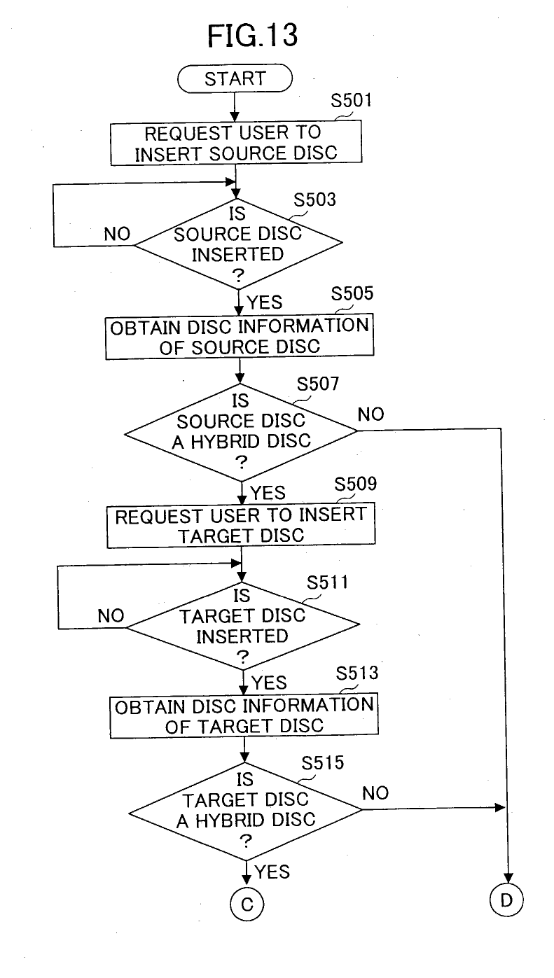

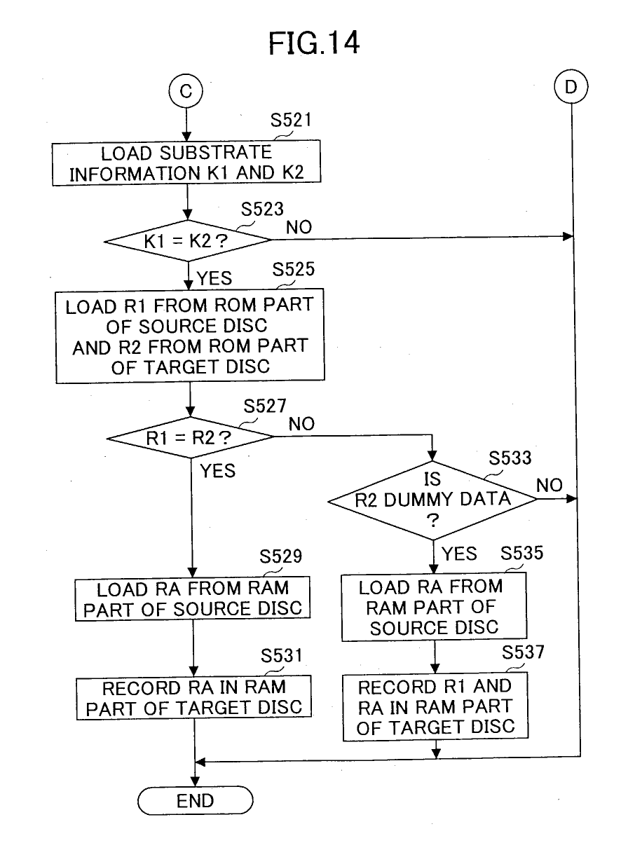

A description will now be given, with reference to FIG. 13 and FIG. 14, of the backup hybrid disc creation operation of the information record system 10′.

FIG. 13 and FIG. 14 are a flowchart of the backup hybrid disc creation operation of the information record system 10′. Referring to FIG. 13, at step S501, a message is displayed on the display device 86 so as to prompt the user to insert a source optical disc, from which a backup hybrid disc is created, into the optical disc apparatus 20a.

At step S503, it is determined whether or not the source optical disc is inserted into the optical disc apparatus 20a. If the MPU 82a receives from the optical disc apparatus 20a a notification that the source optical disc has been inserted, the MPU 82a determines that the source optical disc is inserted (step S503: YES) and then moves to step S505.

At step S505, the MPU 82a obtains disc information recorded in the source optical disc via the optical disc apparatus 20a.

At step S507, the MPU 82a determines whether or not the source optical disc is a hybrid disc with reference to the disc information of the source optical disc. If the source optical disc is not a hybrid disc (step S507: NO), the MPU 82a displays on the display device 86 a message indicating that the source optical disc is not a hybrid disc and terminates the backup hybrid disc creation operation without creation of the backup hybrid disc. On the other hand, if the source optical disc is a hybrid disc (S507: YES), the MPU 82a moves to the step S509.

At step S509, a message is displayed on the display device 86 so as to prompt the user to insert a target optical disc, from which a backup hybrid disc is created, into the optical disc apparatus 20b.

At step S511, the MPU 82a determines whether or not the target optical disc is inserted into the optical disc apparatus 20b. If the MPU 82a receives from the optical disc apparatus 20b a notification that the target optical disc has been inserted, the MPU 82a determines that the target optical disc is inserted (step S511: YES) and then moves to step S513.

At step S513, the MPU 82a obtains disc information recorded in the target optical disc via the optical disc apparatus 20b.

At step S515, the MPU 82a determines whether or not the target optical disc is a hybrid disc with reference to the disc information of the target optical disc. If the target optical disc is not a hybrid disc (step S515: NO), the MPU 82a displays on the display device 86 a message indicating that the target optical disc is not a hybrid disc and terminates the backup hybrid disc creation operation without creation of the backup hybrid disc. On the other hand, if the target optical disc is a hybrid disc (S515: YES), the MPU 82a moves to the step S521.

At step S521 (FIG. 14), the MPU 82a obtains the lead-in start time K1 of the source optical disc via the optical disc apparatus 20a and the lead-in start time K2 of the target optical disc via the optical disc apparatus 20b.

At step S523, the MPU 82a determines whether or not the lead-in start time K1 is equal to the lead-in start time K2. If the lead-in start time K1 is not equal to the lead-in start time K2 (step S523: NO), the MPU 82a displays on the display device 86 a message indicating that the target optical disc is not qualified for a backup hybrid disc and then terminates the backup hybrid disc creation operation without creation of the backup hybrid disc. On the other hand, if the lead-in start time K1 is equal to the lead-in start time K2 (S523: YES), the target optical disc is determined to be qualified for the backup hybrid disc and the MPU 82a moves to the step S525.

At step S525, the MPU 82a obtains the information R1 recorded in the ROM part of the source optical disc via the optical disc apparatus 20a and the information R2 recorded in the ROM part of the target optical disc via the optical disc apparatus 20b.

At step S527, it is determined whether or not the information R1 is identical to the information R2. If the information R1 is identical to the information R2 (step S527: YES), the MPU 82a moves to step S529.

At step S529, the MPU 82a loads the information RA from the RAM part of the source optical disc via the optical disc apparatus 20a.

At step S531, the MPU 82a records the information RA in the RAM part of the target optical disc via the optical disc apparatus 20b. Then, the MPU 82a displays on the display device 86 a message indicating that the backup disc has been properly created and then terminates the backup hybrid disc creation operation.

On the other hand, if the information R1 is not identical to the information R2 (step S527: NO), the MPU 82a moves to step S533.

At step S533, it is determined whether or not the information R2 is predetermined dummy data. If the information R2 is not predetermined dummy data (S533: NO), the MPU 82a displays the message indicative of backup impossibility on the display device 86 and terminates the backup hybrid disc creation operation without creation of the backup hybrid disc. On the other hand, if the information R2 is predetermined dummy data (S533: YES), the MPU 82a moves to step S535.

At step S535, the MPU 82a loads the information RA from the RAM part of the source optical disc via the optical disc apparatus 20a.

At step S537, the MPU 82a records the information R1 and RA in the RAM part of the target optical disc. Then, the MPU 82a displays on the display device 86 the message indicating that the backup disc has been properly created and then terminates the backup hybrid disc creation operation.

In step S537, if it is obvious that the information R2 is not the predetermined dummy data, it is unnecessary for the MPU 82a to make the dummy data determination. In this case, if the information R1 is determined to be not identical to the information R2 at step S527, the MPU 82a may display the message indicative of backup impossibility on the display device 86 without proceeding to step S533 and then terminate the backup hybrid disc creation operation. Furthermore, if the RAM part of the target optical disc does not have a capacity enough to store the information R1 and RA to be copied, the dummy data determination does not have to be made.

Although the structure and the operation of the information record system according to the present invention have been described according to the above embodiments, the information record system is not necessarily limited to such structure and operation.

According to the above-mentioned information record system, it is determined whether or not the information R1 recorded in the ROM part of the source optical disc is identical to the information R2 recorded in the ROM part of the target optical disc at step S203, S303, S427 or S527. However, this determination may be alternatively made by determining whether or not a certain portion of the information R1 is identical to a certain portion of the information R2, as long as this determination result has no problem.

According to the above-mentioned information record system, the lead-in start time is used as the substrate information. However, one of the lead-out start time and the write strategy parameter may be alternatively used. Furthermore, a plurality of information items may be alternatively used as long as at least one of the lead-in start time, the lead-out start time and the write strategy parameter is included in the information items.

According to the above-mentioned information record system, it is determined whether or not a target optical disc is a hybrid disc at step S202, S302, S417 or S515. However, it may be alternatively determined whether or not the target optical disc has predetermined compatibility with a source optical disc even if the target optical disc is not a hybrid disc.

According to the above-mentioned information record system, the information record system adopts the optical disc apparatus that can handle a recording medium in compliance with a standard pertaining to CD descent discs such as CD-ROM (Compact Disc-Read Only Memory), CR-R (Compact Disc-Recordable) and CD-RW (Compact Disc ReWritable). However, the information record system may accommodate an optical disc apparatus that can handle both a recording medium in compliance with a standard pertaining to CD descent discs and an information recording medium in compliance with a standard pertaining to DVD descent discs such as DVD-ROM, DVD-R, DVD+R, DVD-RW and DVD+RW.

According to the above-mentioned information record system, the backup hybrid disc creation program, which is used to control the components of the information record system, is stored in the HDD 84. However, the backup hybrid disc creation program may be alternatively stored in another recording medium such as a CD-ROM, an optical magnetic disc, a flash memory and a flexible disc. In this case, the information record system is configured to have a drive device corresponding to the adopted recording medium, and the backup hybrid disc creation program is installed via the drive device. Hence, the information record system may obtain the backup hybrid disc creation program via an arbitrary information recording medium as long as the backup hybrid disc creation program is properly loaded in the main memory 82b of the information record system.

The present invention is not limited to the specifically disclosed embodiments, and variations and modifications may be made without departing from the scope of the present invention.

The present application is based on Japanese priority applications No. 2002-225682 filed Aug. 2, 2002 and No. 2003-025798 filed Feb. 3, 2003, the entire contents of which are hereby incorporated by reference.

What is claimed is:

1. A method of creating a backup disc of a hybrid type source optical disc having a read-only storage area and a writable storage area, the method comprising:
a qualification determination step of determining whether or not a target optical disc is qualified as the backup disc of the hybrid type source optical disc by comparing the source optical disc to the target optical disc based on information recorded in the source optical disc and the target optical disc;
a loading step of loading, when it is determined that the target optical disc is qualified as the backup disc, backup information from the source optical disc; and
a writing step of writing the backup information in the target optical disc.

2. The method as claimed in claim 1, further comprising:
a disc determination step of determining whether or not the target optical disc is a hybrid type disc, and
wherein the qualification determination step occurs when the disc determination step determines that the target optical disc is a hybrid type disc.

3. The method as claimed in claim 1, further comprising:
a disc determination step of determining whether or not the target optical disc has predetermined compatibility with the hybrid type source optical disc, and
wherein the qualification determination step occurs when the disc determination step determines that the target optical disc has predetermined compatibility with the hybrid type source optical disc.

4. The method as claimed in claim 1, wherein the qualification determination step comprises:
a substrate qualification determination step of determining whether or not the source optical disc and the target optical disc have the same substrate information; and
a ROM qualification determination step of determining whether or not at least a portion of ROM information of the source optical disc in a read-only storage area thereof and at least a portion of ROM information of the target optical disc in a read-only storage area thereof are the same, and
the qualification determination step determines that the target optical disc is qualified as the backup disc when the substrate qualification determination step determines that the source optical disc and the target optical disc have the same substrate information and the ROM qualification determination step determines that the portion of ROM information of the source optical disc and the portion of ROM information of the target optical disc are the same.

5. The method as claimed in claim 4, wherein the substrate information comprises at least one of lead-in start time, lead-out start time and a write strategy parameter.

6. The method as claimed in claim 4, wherein the qualification determination step comprises:
a dummy data determination step of determining whether or not the ROM information of the target optical disc is dummy data when the substrate qualification determination step determines that the source optical disc and the target optical disc have the same substrate information and the ROM qualification determination step determines that the portion of ROM information of the source optical disc and the portion of ROM information of the target optical disc are not the same,
said qualification determination step determining, when the dummy data determination step determines that the ROM information of the target optical disc is dummy data, that the target optical disc is qualified as the backup disc.

7. The method as claimed in claim 1, wherein the backup information comprises RAM information recorded in a writable storage area of the source optical disc, and the writing step writes said RAM information in a writable storage area of the target optical disc.

8. The method as claimed in claim 6, wherein the backup information comprises RAM information recorded in a writable storage area of the source optical disc and the ROM information of the source optical disc, and the writing step writes said RAM information and said ROM information in a writable storage area of the target optical disc when the qualification determination step determines that the target optical disc is qualified as the backup disc based on determination of the dummy data determination step.

9. The method as claimed in claim 1, wherein the hybrid type disc comprises a CD descent disc or a DVD descent disc.

10. A system of creating a backup disc of a hybrid type source optical disc having a read-only storage area and a writable storage area, comprising:
a qualification determination part determining whether or not a target optical disc is qualified as the backup disc of the hybrid type source optical disc by comparing the source optical disc to the target optical disc based on information recorded in the source optical disc and the target optical disc;
a loading part loading, when it is determined that the target optical disc is qualified as the backup disc, backup information from the source optical disc; and
a writing part writing the backup information in the target optical disc.

11. The system as claimed in claim 10, further comprising:
a disc determination part determining whether or not the target optical disc is a hybrid type disc, and
wherein the qualification determination part determines whether or not the target optical disc is qualified as the backup disc when the disc determination part determines that the target optical disc is a hybrid type disc.

12. The system as claimed in claim 10, further comprising:
a disc determination part determining whether or not the target optical disc has predetermined compatibility with the hybrid type source optical disc, and
wherein the qualification determination part determines whether or not the target optical disc is qualified as the backup disc when the disc determination part determines that the target optical disc has predetermined compatibility with the hybrid type source optical disc.

13. The system as claimed in claim 10, wherein the qualification determination part comprises:
a substrate qualification determination part determining whether or not the source optical disc and the target optical disc have the same substrate information; and
a ROM qualification determination part determining whether or not at least a portion of ROM information of the source optical disc in a read-only storage area thereof and at least a portion of ROM information of the target optical disc in a read-only storage area thereof are the same, and
the qualification determination part determines that the target optical disc is qualified as the backup disc when the substrate qualification determination part determines that the source optical disc and the target optical disc have the same substrate information and the ROM qualification determination part determines that the portion of ROM information of the source optical disc and the portion of ROM information of the target optical disc are the same.

14. The system as claimed in claim 13, wherein the substrate information comprises at least one of lead-in start time, lead-out start time and a write strategy parameter.

15. The system as claimed in claim 13, wherein the qualification determination part comprises:
a dummy data determination part determining whether or not the ROM information of the target optical disc is dummy data when the substrate qualification determination part determines that the source optical disc and the target optical disc have the same substrate information and the ROM qualification determination part determines that the portion of ROM information of the source optical disc and the portion of ROM information of the target optical disc are not the same,
said qualification determination part determining, when the dummy data determination part determines that the ROM information of the target optical disc is dummy data, that the target optical disc is qualified as the backup disc.

16. The system as claimed in claim 10, wherein the backup information comprises RAM information recorded in a writable storage area of the source optical disc, and the writing part writes said RAM information in a writable storage area of the target optical disc.

17. The system as claimed in claim 15, wherein the backup information comprises RAM information recorded in a writable storage area of the source optical disc and the ROM information of the source optical disc, and the writing part writes said RAM information and said ROM information in a writable storage area of the target optical disc when the qualification determination part determines that the target optical disc is qualified as the backup disc based on determination of the dummy data determination part.

18. The system as claimed in claim 10, wherein the hybrid type disc comprises a CD descent disc or a DVD descent disc.

19. A computer-readable recording medium for storing a program to cause a computer to execute a procedure of creating a backup disc of a hybrid type source optical disc having a read-only storage area and a writable storage area, the procedure comprising:
a qualification determination step of determining whether or not a target optical disc is qualified as the backup disc of the hybrid type source optical disc by comparing the source optical disc to the target optical disc based on information recorded in the source optical disc and the target optical disc;
a loading step of loading, when it is determined that the target optical disc is qualified as the backup disc, backup information from the source optical disc; and
a writing step of writing the backup information in the target optical disc.

20. The computer-readable recording medium as claimed in claim 19, the procedure further comprising:
a disc determination step of determining whether or not the target optical disc is a hybrid type disc, and
wherein the qualification determination step occurs when the disc determination step determines that the target optical disc is a hybrid type disc.

21. The computer-readable recording medium as claimed in claim 19, the procedure further comprising:
a disc determination step of determining whether or not the target optical disc has predetermined compatibility with the hybrid type source optical disc, and
wherein the qualification determination step occurs when the disc determination step determines that the target optical disc has predetermined-compatibility with the hybrid type source optical disc.

22. The computer-readable recording medium as claimed in claim 19, wherein the qualification determination step comprises:
a substrate qualification determination step of determining whether or not the source optical disc and the target optical disc have the same substrate information; and
a ROM qualification determination step of determining whether or not at least a portion of ROM information of the source optical disc in a read-only storage area thereof and at least a portion of ROM information of the target optical disc in a read-only storage area thereof are the same, and
the qualification determination step determines that the target optical disc is qualified as the backup disc when the substrate qualification determination step determines that the source optical disc and the target optical disc have the same substrate information and the ROM qualification determination step determines that the portion of ROM information of the source optical disc and the portion of ROM information of the target optical disc are the same.

23. The computer-readable recording medium as claimed in claim 22, wherein the substrate information comprises at least one of lead-in start time, lead-out start time and a write strategy parameter.

24. The computer-readable recording medium as claimed in claim 22, wherein the qualification determination step comprises:
a dummy data determination step of determining whether or not the ROM information of the target optical disc is dummy data when the substrate qualification determination step determines that the source optical disc and the target optical disc have the same substrate information and the ROM qualification determination step determines that the portion of ROM information of the source optical disc and the portion of ROM information of the target optical disc are not the same,
said qualification determination step determining, when the dummy data determination step determines that the ROM information of the target optical disc is dummy data, that the target optical disc is qualified as the backup disc.

25. The computer-readable recording medium as claimed in claim 19, wherein the backup information comprises RAM information recorded in a writable storage area of the source optical disc, and the writing step writes said RAM information in a writable storage area of the target optical disc.

26. The computer-readable recording medium as claimed in claim 24, wherein the backup information comprises RAM information recorded in a writable storage area of the source optical disc and the ROM information of the source optical disc, and the writing step writes said RAM information and said ROM information in a writable storage area of the target optical disc when the qualification determination step determines that the target optical disc is qualified as the backup disc based on determination of the dummy data determination step.

27. The computer-readable recording medium as claimed in claim 19, wherein the hybrid type disc comprises a CD descent disc or a DVD descent disc.
